(19) United States
(12) Patent Application Publication
(10) Pub. No.: US 2015/0063599 A1
(43) Pub. Date: Mar. 5, 2015

(54) CONTROLLING LEVEL OF INDIVIDUAL SPEAKERS IN A CONVERSATION

(71) Applicant: Martin David Ring, Ashland, MA (US)

(72) Inventor: Martin David Ring, Ashland, MA (US)

(21) Appl. No.: 14/013,896

(22) Filed: Aug. 29, 2013

(51) Int. Cl. H04R 1/10

(52) U.S. Cl. CPC H04R 1/1083
USPC 381/107

(57) ABSTRACT

A headset includes a microphone for receiving a user's voice, a microphone for receiving ambient noise, a receiver for receiving a plurality of voice signals, a speaker for delivering sound to the user's ear and a processing device. The processing device is configured to identify a signal level of a first one of the plurality of voice signals and a second one of the plurality of voice signals, the signal level of the second voice signal being different than the signal level of the first voice signal. The processing device is also configured to measure the ambient noise level and adjust a gain applied to at least one of the first and second voice signals, taking into consideration the ambient noise level. The first and second voice signals are provided to the speaker.

### BACKGROUND

This disclosure relates to assisting hearing, and in particular, to allowing two or more headsets users in a noisy environment to speak with ease and hear each other with ease.

Carrying on a conversation in a noisy environment, such as a factory floor, construction worksite, aircraft, or crowded restaurant can be very difficult. For example, the person speaking has trouble hearing their own voice, and must raise it above what may be a comfortable level just to hear themselves, let alone for anyone else to hear them. The speaker may also have difficulty gauging how loudly to speak to allow the other person(s) to hear them. Likewise, the person(s) listening must strain to hear the person speaking, and to pick out what was said. Even with raised voices, intelligibility and listening ease suffer.

The situation is further complicated as the number of headset users, and thus the number of people carrying on a conversation, increases. Since each user may speak at a different volume, a person listening may have difficulty hearing the users that speak quietly compared to the users that speak loudly. Increasing the headset volume so that a person speaking quietly can be heard results in other people sounding too loud. Thus, in a multi-user headset environment, intelligibility and listening ease further suffer.

### SUMMARY

In general, in some aspects, a headset includes a microphone for receiving a user's voice, a microphone for receiving ambient noise, a receiver for receiving a plurality of voice signals, a speaker for delivering sound to the user's ear and a processing device. The processing device is configured to identify a signal level of a first one of the plurality of voice signals and a second one of the plurality of voice signals, the signal level of the second voice signal being different than the signal level of the first voice signal. The processing device is also configured to measure the ambient noise level and adjust a gain applied to at least one of the first and second voice signals, taking into consideration the ambient noise level. The first and second voice signals are provided to the headset's speaker.

Implementations may include any, all or none of the following features. Adjusting a gain applied to at least one of the first and second voice signals may normalize the signal levels of the first and second voice signals. The signal levels of the voice signals provided to the headset's speakers may be substantially the same or may be a predetermined level above the ambient noise level. The headset may include a user control for individually adjusting the signal level of each voice signal received by the headset. An individual adjustment may cause the processing device to adjust a gain applied to one of the received voice signals. The processing device may be configured to store data associated with an individual adjustment and automatically apply the individual adjustment to the received voice signal when subsequently received.

The processing device may be configured to identify a signal level of a third one of the plurality of voice signals, the signal level of the third voice signal being different than the signal level of the first and second voice signals. The processing device may be configured to adjust a gain applied to the third voice signal, taking into consideration the signal level of the first and second voice signals and the ambient noise level. The processing device may be configured to provide the third voice signal to the speaker. Adjusting a gain applied to the third voice signal may normalize the signal level of the third voice signal.

The headset may also include a storage accessible to the processing device that stores a series of instructions that are executed by the processing device.

In general, in some aspects, in a headset having a microphone for receiving a user's voice, a microphone for receiving ambient noise, a receiver for receiving a plurality of voice signals and a speaker for delivering sound to the user's ear, a method that includes identifying a signal level of a first one of the plurality of voice signals and a second one of the plurality of voice signals, the signal level of the second voice signal being different than the signal level of the first voice signal. The method also includes measuring the ambient noise level and adjusting a gain applied to at least one of the first and second voice signals, taking into consideration the ambient noise level. The method further includes providing the first and second voice signals to the speaker.

Implementations may include any, all or none of the following features. Adjusting the gain applied to at least one of the first and second voice signals may normalize the signal levels of the first and second voice signals. Adjusting the gain applied to at least one of the first and second voice signals may correspond to an adjustment in sound volume delivered to the ear of the user for the adjusted signal. Adjusting the gain may result in the signal levels of the first and second voice signals being substantially the same or at a predetermined level.

A user may individually adjust the signal level of each received voice signal. The method may also include adjusting a gain applied to one of the received voice signals based on an individual adjustment made by the user, storing data associated with the individual adjustment and automatically applying the individual adjustment to the received voice signal when subsequently received.

The method may also include identifying a signal level of a third one of the plurality of voice signals, the signal level of the third voice signal being different than the signal level of the first and second voice signals. The method may further include adjusting a gain applied to the third voice signal, taking into consideration the signal level of the first and second voice signals and the ambient noise level. The third voice signal may be provided to the speaker. Adjusting a gain applied to the third voice signal may normalize the signal level of the third voice signal.

In general, in some aspects, in a system of headsets, each headset has a microphone for receiving a headset user's voice, a microphone for receiving ambient noise, a transmitter for transmitting the headset user's voice to the other headsets, a receiver for receiving a plurality of voice signals from the other headsets and a speaker for delivering sound to the user's ear. Each headset is configured to adjust a signal level of its user's voice to be transmitted to the other headsets. The signal level is adjusted so that it is substantially the same as a signal level of a first one of the plurality of voice signals received from one of the other headsets, a predetermined signal level, or a common signal level negotiated among the headsets based on the ambient noise level measured by the headsets.

Implementations may include any, all or none of the following features. Each of the headsets may adjust the signal level of its user's voice by adjusting a gain applied to signals associated with the user's voice, taking into consideration the ambient noise level. Each headset may also include a user control for individually adjusting the signal level of each voice signal received by the headset. Each headset may adjust the signal level of its user's voice to be transmitted to the other headsets based on individual adjustments made by the headset users. The headsets may communicate through a private network.

In general, in some aspects, in a system of headsets, each headset has a first microphone for receiving a headset user's voice, a second microphone for receiving ambient noise, a receiver for receiving voice signals from the other headsets and a speaker for delivering sound to the user's ear. Each headset is configured to identify a signal level of a first and second one of the voice signals, the signal level of the second voice signal being different than the signal level of the first voice signal. Each headset is also configured to measure the ambient noise level and adjust a gain applied to at least one of the first and second voice signals to normalize the signal levels, taking into consideration the ambient noise level. Each headset is further configured to provide the first and second voice signals to the speaker.

Implementations may include any, all or none of the following features. The headsets may communicate through a private network. Each headset may include a user control to individually adjust the signal level of each voice signal received by the headset. Each headset may be configured to adjust the signal level of each voice signal received by the headset based on individual adjustments made by the headset users. The signal levels of the signals provided to the speaker may be substantially the same or may be a predetermined level above the ambient noise level.

Advantages include improved intelligibility and listening ease for two or more headset users near each other in a noisy environment and control over the volume of individual voice signals received and played by a headset.

Implementations may include one of the above and/or below features, or any combination thereof. Other features and advantages will be apparent from the description and the claims.

### BRIEF DESCRIPTION OF THE DRAWINGS

FIGS. 1 through 3 show configurations of headsets and electronic devices used in conversations.

FIGS. 4 through 7 show circuits for implementing the devices of FIGS. 1 through 3.

FIGS. 8 through 10 show block diagrams of algorithms that may be implemented in the devices of FIGS. 1 through 3.

FIG. 11 shows a more detailed implementation of the circuit of FIG. 4.

### DETAILED DESCRIPTION

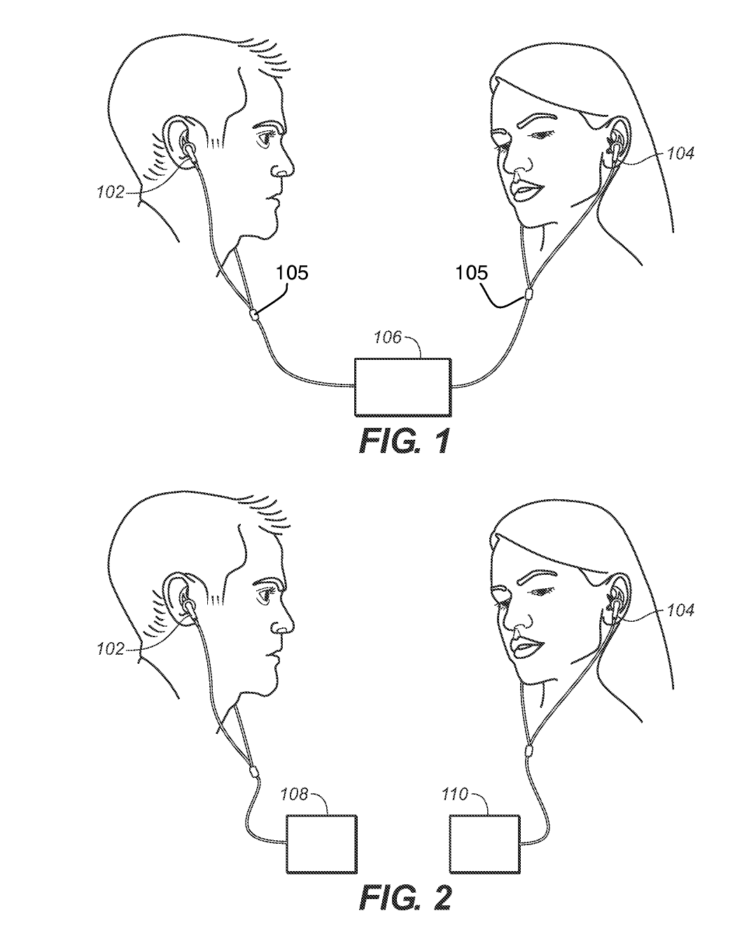

A system for allowing two or more headset users in a noisy environment to speak with ease and hear each other with ease includes two headsets 102, 104, and at least one electronic device 106 in communication with both headsets, as shown in FIG. 1. Each headset 102, 104 may isolate a user from ambient noise, which may be done passively through acoustic structures or actively through an active noise reduction (ANR) system. An active noise reduction system will generally work in conjunction with passive noise reduction features. Each headset 102, 104 also includes a voice microphone for detecting the speech of its own user. In some examples, the voice microphone is also used as part of the ANR system, such as a feed-forward microphone detecting ambient sounds or a feed-back microphone detecting sound in the user's ear canal. In other examples, the voice microphone is a separate microphone optimized for detecting the user's speech and rejecting ambient noise, such as a boom microphone or a microphone array configured to be sensitive to sound coming from the direction of the user's mouth. Each headset 102, 104 provides its voice microphone output signal to an electronic device 106.

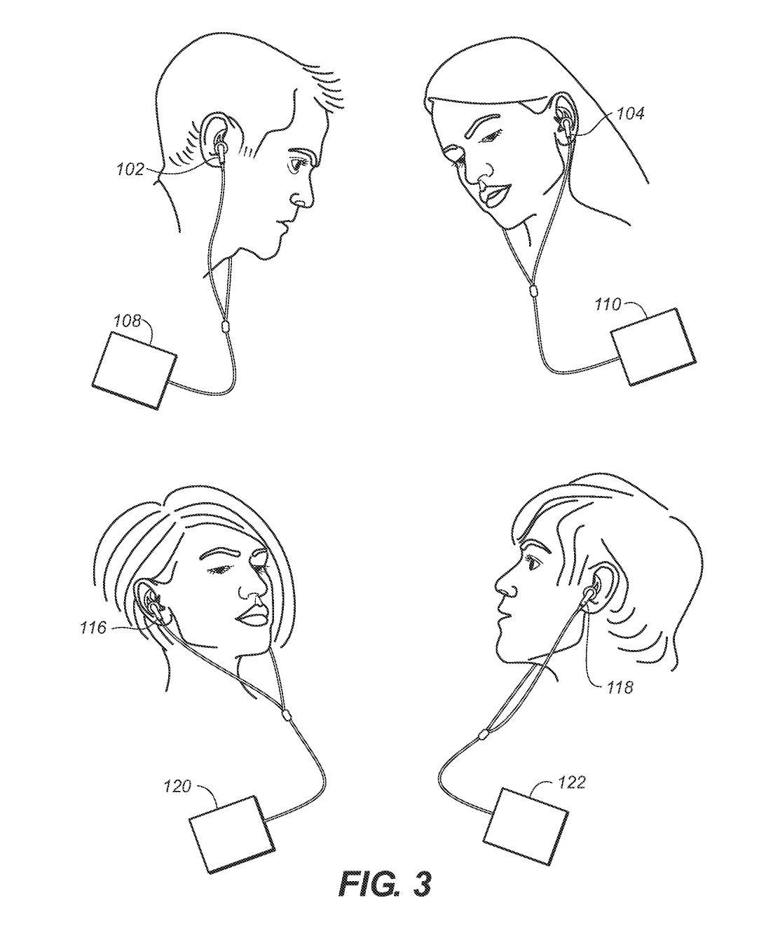

In some examples, as shown in FIGS. 2 and 3, each headset is connected to a separate electronic device, i.e., devices 108 and 110 in FIG. 2 and devices 108, 110, 120 and 122 in FIG. 3. In FIG. 3, four users are shown having a conversation, each user with a headset 102, 104, 116, 118 connected to a respective electronic device 108, 110, 120, 122. A multi-user conversation may also use a single electronic device, such as device 106 in FIG. 1, or two or more (but fewer than the number of headsets) devices that each communicate with at least one of the headsets and with each other. In some examples, the electronic devices are fully integrated into the headsets. The processing described below as taking place in circuitry may be performed in each of the distributed electronic devices from FIGS. 2 and 3, or all in one electronic device, such as the common device in FIG. 1, or in one of the distributed electronic devices to generate signals for re-distribution back to the other distributed electronic devices, or in any practical combination.

Although the headsets are shown as connected to the electronic devices by wires, the connection could be wireless, using any suitable wireless communication method, such as Bluetooth®, WiFi, or a proprietary wireless interface. In addition to communicating with the headsets, the electronic devices may be in communication with each other using wired or wireless connections. The wireless connection used for communication between the electronic devices may be different than that used with the headsets. For example, the headsets may use Bluetooth to communicate with the electronic devices, while the electronic devices may use WiFi to communicate with each other. The headsets and electronic devices may communicate via a public or private network, and the network may be real or virtual.

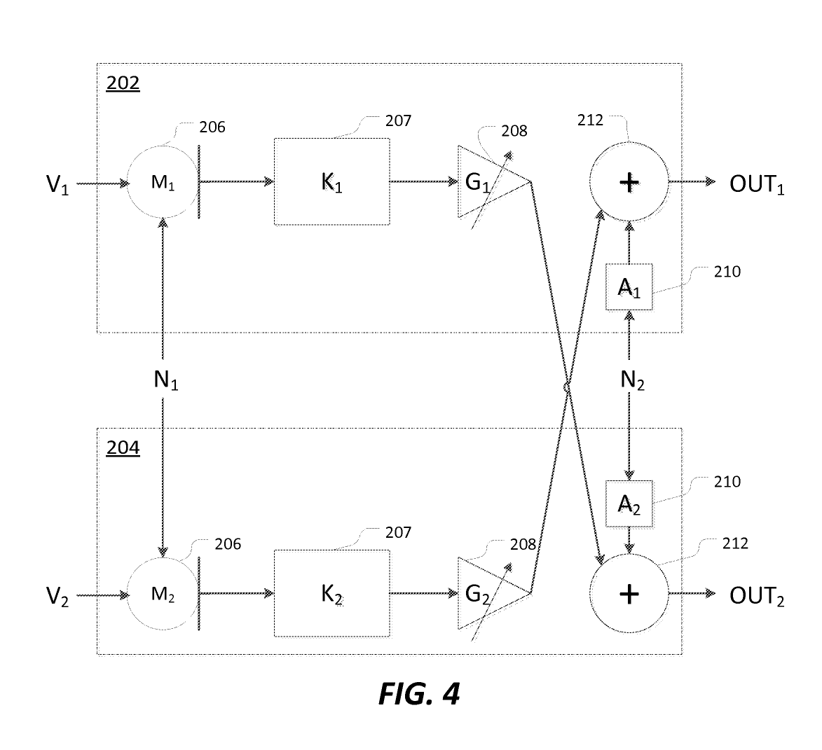

As shown in FIG. 4, circuitry in the electronic device or devices processes the voice microphone signals from each headset. Two systems 202 and 204 are shown in FIG. 4. The systems 202 and 204 may be implemented in separate electronic devices, in each of the electronic devices, or within a single electronic device. For example, system 202 may reside in electronic device 108, while system 204 may reside in electronic device 110 of FIG. 2. Alternatively, systems 202 and 204 may both reside in each of the electronic devices 108, 110 of FIG. 2. Alternatively, systems 202 and 204 may both reside in electronic device 106 of FIG. 1. The circuitry of systems 202, 204 may be implemented with discrete electronics, by software code running on a digital signal processor (DSP) or any other suitable processor within or in communication with the electronic device or devices.

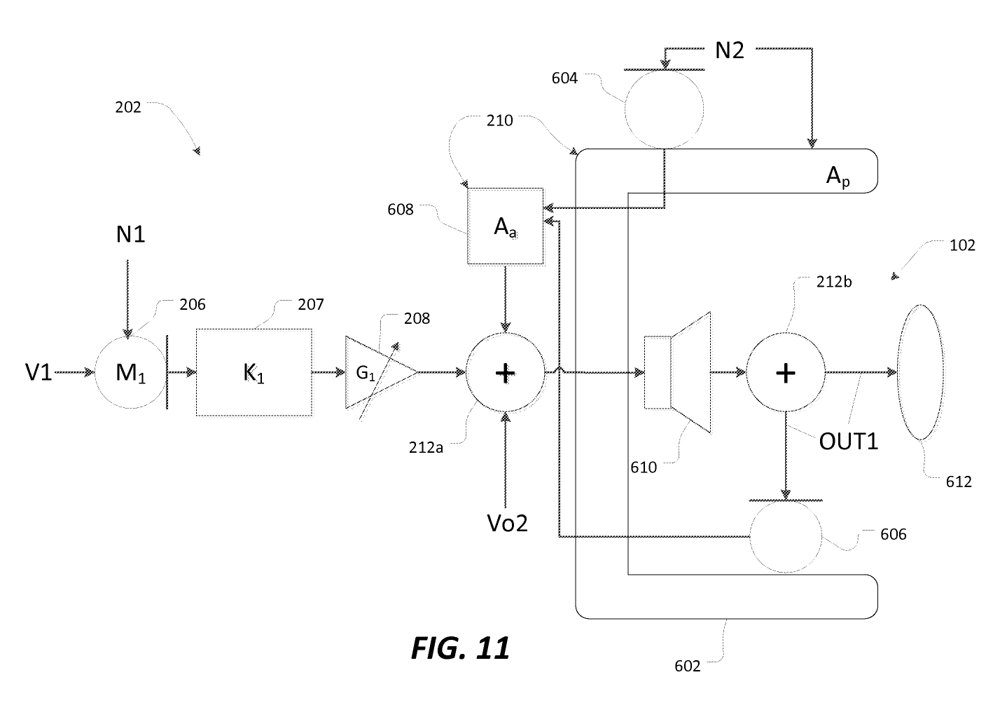

Each system 202, 204 includes a voice microphone 206 receiving a voice input V1 or V2, an equalization stage 207, a gain stage 208, an attenuation block 210, and an output summation node 212 providing an output signal OUT1 or OUT2. The voice inputs V1 and V2 represent the actual voices of headset users, and the output signals OUT1 and OUT2 represent the acoustic signals output through the headsets' speakers and heard by the users. The microphones 206 also detect ambient noise N1, which is filtered according to the microphones' noise rejection capabilities. The processing applied to the voice inputs V1 and V2 within the microphones 206 may be different from the processing applied to the ambient noise N1. For example, if the microphone is a noise-rejecting type then its response to a near sound source will be different than its response to a far sound source. Ambient noise N2, which may be the same as N1, is attenuated by the attenuation block 210, which represents the combined passive and active noise reduction capability of the headsets. The residual noise is shown entering the output summation node 212, though in actual implementation, the electronic signals are first summed and output by an output transducer, and the output of the transducer is acoustically combined with the residual noise within the user's ear canal. Thus, in FIG. 4, the output node 212 represents the output transducer in combination with its acoustic environment, as shown in more detail in FIG. 11.

Systems 202 and 204 apply the same processing to the voice and noise input signals. First, each voice signal is filtered by an equalization stage 207, which applies a filter Kᵢ, and amplified by a gain stage 208, which applies a gain Gᵢ. The filter Kᵢ, and gain Gᵢ, change the shape and level of the voice signal to optimize it for the environment in which the headsets are being used. For example, the voice output filter Kᵢ, and gain Gᵢ, are selected to make the voice signal from one headset's microphone audible and intelligible to the user of the second headset, when played back in the second headset. The filtered and scaled voice output signals are each delivered to the other headset, where they are acoustically combined with the attenuated noise signal to produce a combined output signal. The voice signal from one headset, played back by the headset under consideration, is referred to herein as the far-end voice signal.

The filtered and scaled voice output signal, processed in the manner described above, is delivered from one headset to another headset via a transmitter. The transmitted voice output signal is received by the other headset using a receiver. For simplicity, the transmitter and receiver are not shown in FIG. 4. The transmitter and receiver may be implemented using any suitable method, including wire, radio frequency (RF) or infrared (IR) circuitry. Once the voice output signal is received by the other headset, it is played through the headset's speaker.

As also shown in FIG. 4, the microphones 206 detect ambient noise N1 and deliver it to the equalization stage 207 and gain stage 208 along with voice signals V1 and V2. Ambient noise N2, which may be the same as N1, is attenuated by noise reduction features of the headsets, whether active or passive, such that the attenuated noise signal Aᵢ*N2 is heard in each headset, along with the far-end voice signal.

The gain Gᵢ is selected to provide output signals OUT1 and OUT2 to the headsets at levels that will allow each headset user to hear the other user's voice at a comfortable and intelligible level. In selecting the gain Gᵢ, various factors are taken into account, including the noise rejection capabilities of the microphones, the noise attenuation capabilities of the headsets, the level of ambient noise in the environment in which the headsets are being used, and the initial level of the voice signals V1 and V2 received by the microphones.

The circuitry shown in FIG. 4 produces complementary output signals, OUT₁=(V₂+N₁)(M₂*K₂*G₂)+N₂*A₁ and OUT₂=(V₁+N₁)(M₁*K₁*G₁)+N₂*A₂, where Mᵢ represents the sensitivity frequency response of the microphones 206 (more specifically, Mᵢ=output voltage/input sound pressure), such that N₁*Mᵢ is the noise in the input voice signals. Where the headsets are the same model, the filters Kᵢ, gains Gᵢ, ambient noise attenuation and microphone responses may be the same. Alternatively, the filter Kᵢ and gain Gᵢ may be empirically determined based on the actual acoustics of the headset in which the circuitry is implemented and on the sensitivity of the microphones. Thus, the filter Kᵢ and gain Gᵢ may be different in different headsets. If the headsets are different, the microphones Mᵢ and attenuation stages Aᵢ may also differ.

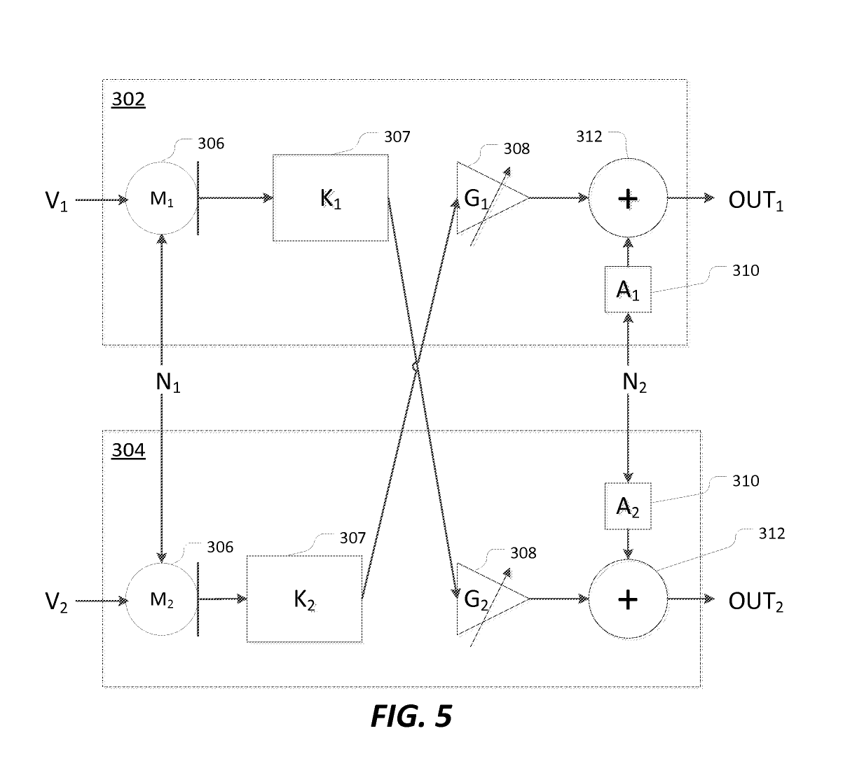

FIG. 5 shows a variation on the circuitry of FIG. 4, with systems 302 and 304 each transmitting their equalized output voice signal (Vᵢ+N₁)(Mᵢ*Kᵢ) to the other system before a gain Gᵢ is applied at the gain stages 308, instead of a gain Gᵢ being applied before transmission to the other headset. The voice output filters in the equalization stages 307 remain with the source device, filtering the voice signal based on the properties of the corresponding microphone, and are shown as possibly being different between devices.

Similarly, the default values of the gains G₁ and G₂ attenuation stages A₁ and A₂, and microphones M₁ and M₂ may also be different, for example if the headsets are different models with different responses. In FIG. 5 (as in FIG. 4), the gains applied to the voice input signals, as shown in gain stage 308, are numbered G₁ and G₂, and the filters of the equalization stage 307 are numbered K₁ and K₂, to indicate that they may be different. The microphones are numbered M₁ and M₂, and the attenuation stages are numbered A₁ and A₂, to also indicate that they may be different. In FIG. 5, the output signals will be OUT₁=(V₂+N₁)(M₂*K₂)*G₁+N₂*A₁ and OUT₂=(V₁+N₁)(M₁*K₁)*G₂+N₂*A₂. As in FIG. 4, the filtered and scaled voice output signals are delivered from one headset to another headset via a transmitter. The transmitted voice output signal is received by the other headset using a receiver.

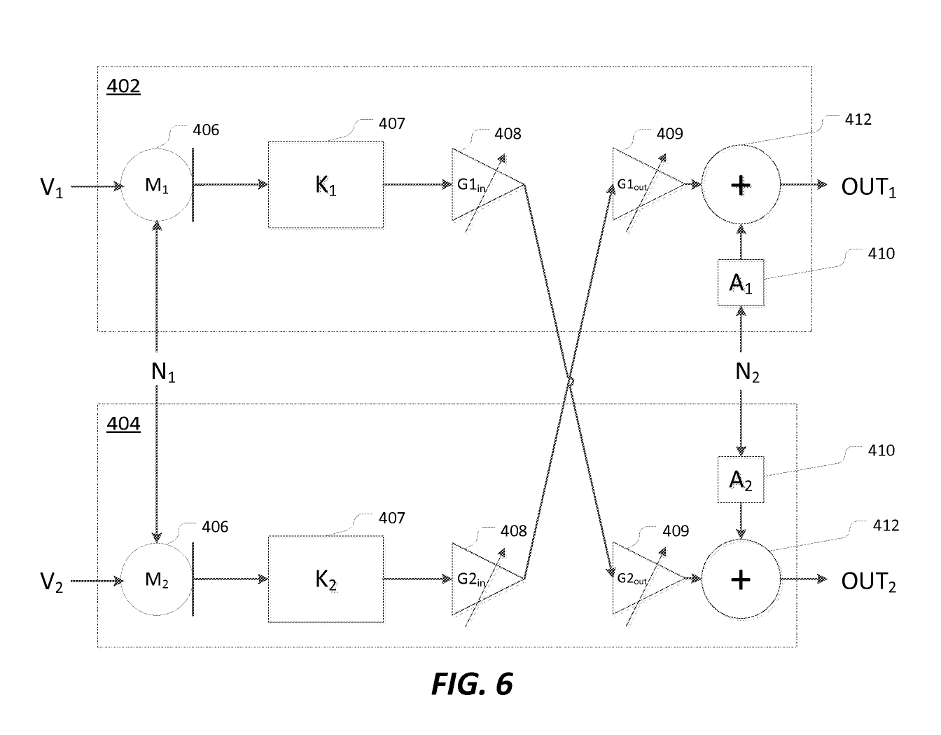

As shown in FIG. 6, the examples of FIGS. 4 and 5 may be combined, with gain applied to the output voice signal at both the headset generating it and the headset receiving it. In FIG. 6, systems 402 and 404 each contain an equalization stage 407, applying a filter Kᵢ, an input gain stage 408, applying a gain Giᵢₙ, and an output gain stage 409, applying a gain Giₒᵤₜ. Applying gain at both ends allows the headset generating the voice signal to apply a gain Giᵢₙ based on knowledge of the acoustics of that headset's microphone, and the headset receiving the signal to apply an additional gain (or attenuation) Giₒᵤₜ based on knowledge of the acoustics of that headset's output section and the user's preference. In this example, the output signals are OUT₁=(V₂+N₁)(M₂*K₂*G₂_{ᵢₙ})*G₁_{ₒᵤₜ}+N₂*A₁ and OUT₂=(V₁+N₁)(M₁*K₁*G₁_{ᵢₙ})*G₂_{ₒᵤₜ}+N₂*A₂. As in FIGS. 4 and 5, the filtered and scaled voice output signals are delivered from one headset to another headset via a transmitter. The transmitted voice output signal is received by the other headset using a receiver.

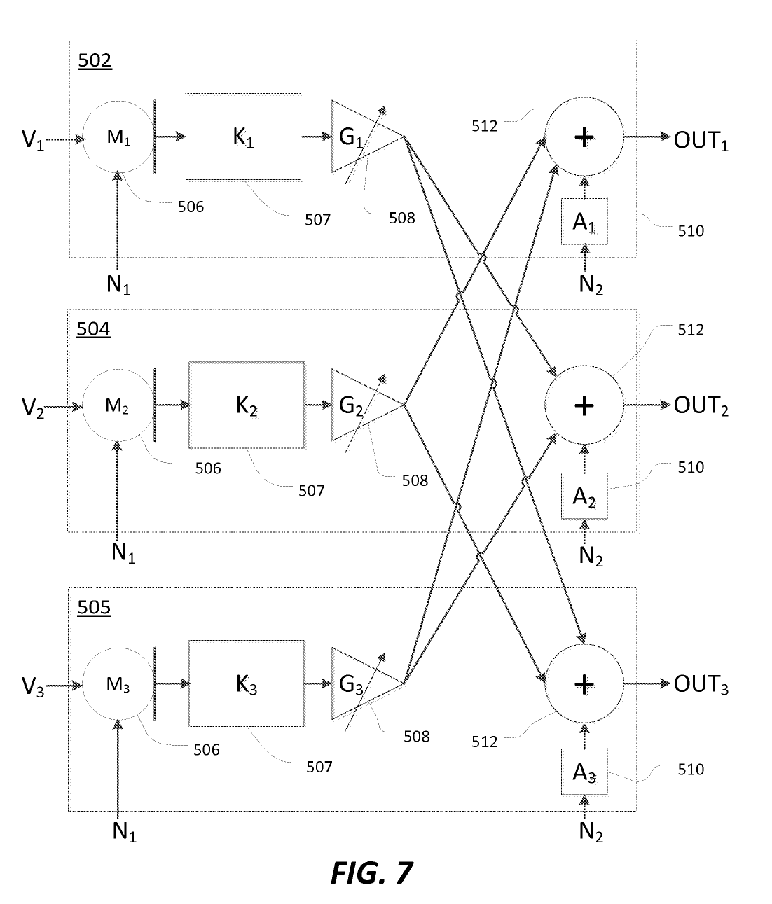

In some examples, as shown in FIG. 7, the system is extended to have three or more headset users sharing in a conversation. Although FIG. 7 shows systems 502, 504 and 505 implemented with the circuitry of FIG. 4 for simplicity, systems 502, 504 and 505 could alternatively be implemented with the circuitry of FIG. 5 or 6. In FIG. 7, the noise sources N1 and N2 are shown separately for each headset, but if the users are in the same local environment, these would be substantially the same for each headset. As shown, each of the output voice signals (Vᵢ+Nᵢ)(Mᵢ*Kᵢ*Gᵢ) is provided to each of the other headset circuits. The circuitry is the same as in FIG. 4, except that the summation nodes 512 have more inputs. The equalization stages 507 apply a filter Kᵢ and the gain stages 508 apply a gain Gᵢ. The filter Kᵢ and gain Gᵢ values may be the same between the headsets, or may be different, depending on the characteristics of the headsets. At each headset circuit, the far-end voice signal is combined with attenuated ambient noise N2 (which may be the same as N1). As in FIGS. 4 through 6, the filtered and scaled voice output signals are delivered from one headset to another headset via a transmitter. The transmitted voice output signal is received by the other headset using a receiver.

For each of the systems shown in FIGS. 4 through 7, a user control may be provided on each headset, to allow the user to compensate for his own hearing ability or preference by adjusting the volume of the output signals delivered to the headset's speakers. The user control adjusts the volume only of the far-end voice signal currently being played back in the headset. That is, the volume change is not globally applied to any other far-end voice signal received by the headset. Accordingly, a user can make individualized adjustments to the far-end voice signals, decreasing the volume of a voice he finds too loud and/or increasing the volume of a voice he finds too quiet. This is accomplished by increasing or decreasing the gain applied to the corresponding output signal. An adjustment in the gain applied to the output signal corresponds to an adjustment in sound volume delivered to the ear of the user. The user may adjust the volume of the voice signals so that the user perceives all participants in the conversation at the same level, regardless of how loudly each person is actually speaking. Alternatively, the user may prefer to increase the volume for certain voices while decreasing the volume for other voices. Any user-adjustment in volume made on a particular far-end voice signal may be saved by the system so that it may be automatically applied the next time that user speaks.

The user control may be provided through any suitable volume control, such as a knob, button or other mechanical structure, or through on-board DSP. The user control may be disposed on a headset (e.g., integrated with the wiring or disposed on the portion of the headset in the user's ear) or it may be disposed on an electronic device.

Alternatively or in addition to the individual user control, the system may automatically adjust the gain applied to a far-end voice signal to compensate for the environment in which the conversation is taking place. For example, as with the individual user control, the system may automatically decrease the volume of a relatively loud voice and automatically increase the volume of a relatively quiet voice. In some examples, the system automatically adjusts the volume of the far-end voice signals so that a user receiving the voice signals (through the headset's speaker) perceives all participants in the conversation at the same level, regardless of how loudly each person is actually speaking. In making the automatic adjustments, the system takes into account several factors, including the ambient noise level and the volume level of the individual speakers in the conversation.

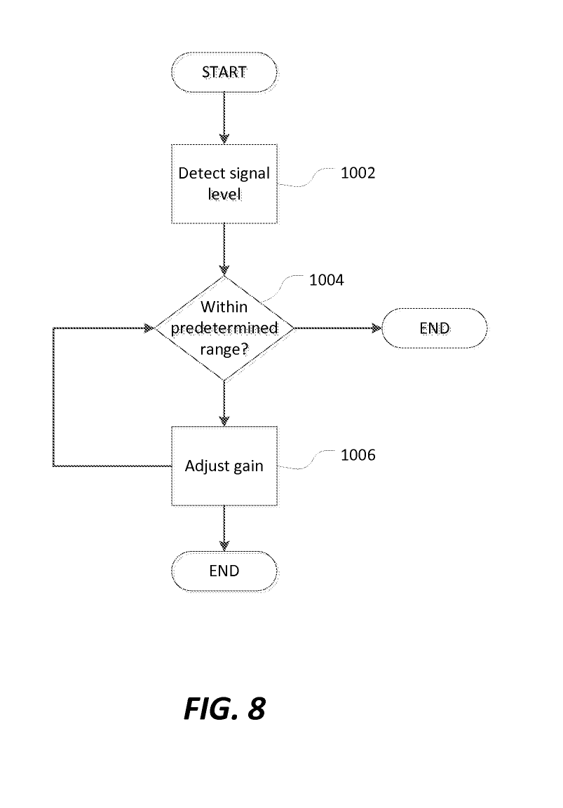

The automatic volume adjustment could be accomplished in a number of ways. In some examples, the system adjusts the volume of each voice signal so that each signal is within a predetermined range of output volumes. An example of such an algorithm is shown in FIG. 8. The system detects a voice signal level in block 1002 and then, in block 1004, determines if the detected signal is within a predetermined range of output volumes. The predetermined range may vary based on the environment in which the conversation is taking place, taking into account the ambient noise in the environment. For example, in a quiet environment, the predetermined range of output volumes may be lower than in a noisy environment. The predetermined range of output volumes may be set so to be a certain level above the ambient noise level measured in the environment. If the detected signal level is not within the predetermined range, in block 1006, the system adjusts the gain applied to the signal to bring it within the predetermined range. The same algorithm may be used to adjust the gain applied to other voice signals in the conversation. Thus, a user perceives all participants in the conversation at substantially the same appropriate level.

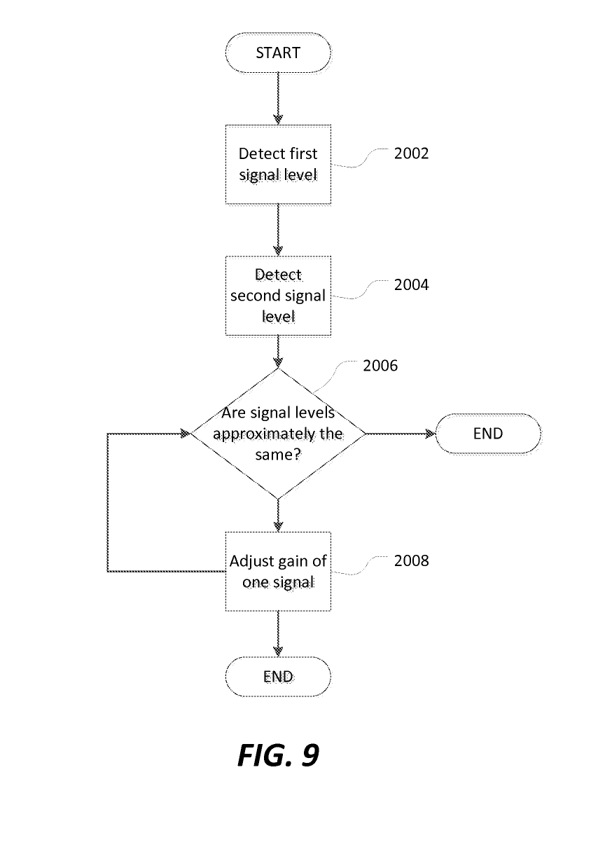

In some examples, the system adjusts the volume of a voice signal to be substantially the same as another voice signal in the conversation. An example of such an algorithm is shown in FIG. 9. In this example, the system detects a first voice signal level in block 2002 and a second voice signal level in block 2004. The system then determines if the signal levels are approximately the same, in block 2006. If the signal levels are not substantially the same, in block 2008, the system adjusts the gain applied to at least one of the signals to make the volumes of the signals substantially the same. The system could determine which signal to adjust by taking into account the ambient noise level in the environment, and adjusting the signal that would be too loud or too quiet relative to the other signal, given the level of ambient noise. While FIG. 9 shows two signals being detected, the same algorithm could be used to detect additional signal levels, and adjust the gain applied to multiple signals to match the volume of one of the other signals. Accordingly, the system automatically adjusts the volume of individual voice signals so that each user is perceived at substantially the same level, regardless of the volume at which the user is actually speaking.

In some examples, the system makes automatic adjustments to the volume of individual voice signals based on individual adjustments made by the headset users. For example, where one or more users in a conversation individually adjust the volume for a particular voice signal, the system learns from those individual adjustments, and automatically decreases or increases the volume of that user's voice before it is delivered to the other headsets.

While each of the automatic volume adjustment algorithms has been described individually, the system could implement all of the algorithms, a subset of the algorithms, or any suitable combination. Moreover, the automatic adjustment algorithms may be combined with the individual user volume controls.

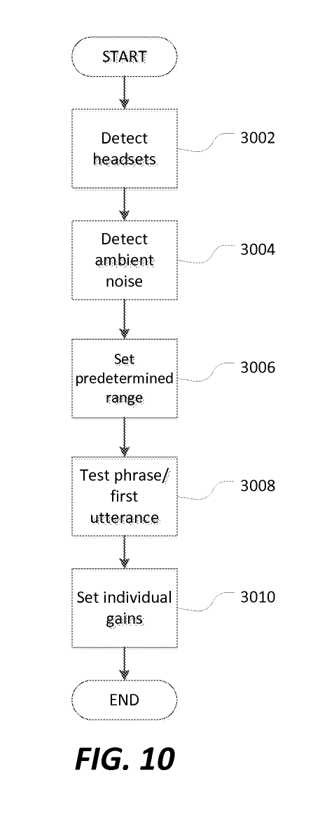

As depicted in FIG. 10, on startup or whenever a new user and headset are added to the conversation, the system may implement an initialization program to determine initial settings for the automatic volume adjustment algorithms. In block 3002, the system scans the environment to detect the number and location of the headsets. In block 3004, the system detects the ambient noise level at each headset. Based on the ambient noise level, in block 3006, the system sets the predetermined range of volume levels as the desired target for each of the voice signals. As shown in block 3008, the system may require each headset user to speak a test phrase, or the first utterance spoken by the user may be used to determine a baseline signal level for each of the voice signals. Based on the test phrases or utterances, in block 3010, the system sets a gain to be applied to each of the voice signals to compensate for users who are speaking too quietly or loudly for the level of ambient noise in the environment. Thus, the initialization program establishes initial volume settings for each of the speakers in the conversation. Following initialization, the system may make further adjustments, automatically or through manual adjustments made by the individual users.

FIG. 11 shows a more detailed view of the system 202 from FIG. 4, including an example of the noise cancellation circuit (abstracted as attenuation block 210 in FIG. 4) and the electro-acoustic system (abstracted as summing node 212 in FIG. 4). The same noise cancellation circuitry and electro-acoustic system may be applied to the circuitry in any of FIGS. 4 through 7. The attenuation block 210 includes a passive attenuation element 602, which represents the physical attenuation provided by the headset structures, applying an attenuation Aₚ to noise N2. The attenuation block 210 may also encompass an active noise reduction circuit 608 connected to one or more feed-forward microphones 604 and/or one or more feed-back microphones 606. The microphones provide noise signals to the acoustic noise reduction circuit 608, which applies an active noise reduction filter to generate anti-noise sounds to be played back by the output transducer of the headset. The active attenuation is represented as having value Aₐ. The acoustic structures and electronic circuitry for such an active noise reduction system are described in U.S. patent application Ser. No. 13/480,766 and Publication 2010/02702277, both incorporated here by reference. The electronic output signals, which include the voice output signal from the other headset (Vo2) and anti-noise signal Aₐ*N2 are summed at the input 212a to an output electro-acoustic transducer 610 in the headphone 102. The acoustic output of the transducer is then summed acoustically with the residual noise Aₚ*N2 present inside the headphone, represented as an acoustic sum 212b. The combined acoustic signals are detected by both the feed-back microphone 606 and the eardrum 612.

Embodiments of the systems and methods described above may comprise computer components and computer-implemented steps that will be apparent to those skilled in the art. For example, it should be understood by one of skill in the art that any computer-implemented steps may be stored as computer-executable instructions on a computer-readable medium such as, for example, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component.

A number of implementations have been described. Nevertheless, it will be understood that additional modifications may be made without departing from the scope of the inventive concepts described herein, and, accordingly, other embodiments are within the scope of the following claims.

What is claimed is:

1. A headset comprising:
a microphone for receiving a user's voice;
a microphone for receiving ambient noise;
a receiver for receiving a plurality of voice signals;
a speaker for delivering sound to an ear of the user; and
a processing device configured to:
identify a signal level of a first one of the plurality of voice signals;
identify a signal level of a second one of the plurality of voice signals,
the signal level of the second voice signal being different than the signal level of the first voice signal;
measure a level of ambient noise;
adjust a gain applied to at least one of the first and second voice signals, taking into consideration the level of ambient noise; and
provide the first and second voice signals to the speaker.

2. The headset of claim 1, wherein adjusting a gain applied to at least one of the first and second voice signals normalizes the signal levels of the first and second voice signals.

3. The headset of claim 1, wherein the signal levels of the signals provided to the speaker are substantially the same.

4. The headset of claim 1, wherein the signal levels of the signals provided to the speaker are at a predetermined level above the level of ambient noise.

5. The headset of claim 1, further comprising a user control for individually adjusting the signal level of each received voice signal.

6. The headset of claim 5, wherein an individual adjustment causes the processing device to adjust a gain applied to one of the received voice signals.

7. The headset of claim 6, wherein the processing device is further configured to store data associated with the individual adjustment and automatically apply the individual adjustment to the one of the received voice signals when subsequently received.

8. The headset of claim 1, wherein the processing device is further configured to:
identify a signal level of a third one of the plurality of voice signals, the signal level of the third voice signal being different than the signal level of the first and second voice signals;
adjust a gain applied to the third voice signal, taking into consideration the signal level of the first and second voice signals and the level of ambient noise; and
provide the third voice signal to the speaker.

9. The headset of claim 8, wherein adjusting a gain applied to the third voice signal normalizes the signal level of the third voice signal.

10. The headset of claim 1, further comprising a storage accessible to the processing device and storing a series of instructions that are executed by the processing device.

11. In a headset having a microphone for receiving a user's voice, a microphone for receiving ambient noise, a receiver for receiving a plurality of voice signals, and a speaker for delivering sound to an ear of the user, a method comprising:
identifying a signal level of a first one of the plurality of voice signals;
identifying a signal level of a second one of the plurality of voice signals, the signal level of the second voice signal being different than the signal level of the first voice signal;
measuring a level of ambient noise;
adjusting a gain applied to at least one of the first and second voice signals, taking into consideration the level of ambient noise; and
providing the first and second voice signals to the speaker.

12. The method of claim 11, wherein adjusting the gain applied to at least one of the first and second voice signals normalizes the signal levels of the first and second voice signals.

13. The method of claim 11, wherein adjusting the gain applied to at least one of the first and second voice signals corresponds to an adjustment in sound volume delivered to the ear of the user for the adjusted signal.

14. The method of claim 11, wherein the step of adjusting the gain applied to at least one of the first and second voice signals results in the signal levels of the first and second voice signals being substantially the same.

15. The method of claim 11, wherein the step of adjusting the gain applied to at least one of the first and second voice signals results in the signal levels of the first and second voice signals being at a predetermined level.

16. The method of claim 11, wherein the user is able to individually adjust the signal level of each received voice signal.

17. The method of claim 16, further comprising:
adjusting a gain applied to one of the received voice signals based on an individual adjustment made by the user;
storing data associated with the individual adjustment; and
automatically applying the individual adjustment to the one of the received voice signals when subsequently received.

18. The method of claim 11, further comprising:
identifying a signal level of a third one of the plurality of voice signals, the signal level of the third voice signal being different than the signal level of the first and second voice signals;
adjusting a gain applied to the third voice signal, taking into consideration the signal level of the first and second voice signals and the level of ambient noise; and
providing the third voice signal to the speaker.

19. The method of claim 18, wherein adjusting a gain applied to the third voice signal normalizes the signal level of the third voice signal.

20. A system of headsets, each having a microphone for receiving a headset user's voice, a microphone for receiving ambient noise, a transmitter for transmitting the headset user's voice to the other headsets, a receiver for receiving a plurality of voice signals from the other headsets, and a speaker for delivering sound to an ear of the user, each of the headsets configured to adjust a signal level of its user's voice to be transmitted to the other headsets to be one of:
(a) substantially the same as a signal level of a first one of the plurality of voice signals received from one of the other headsets;
(b) a predetermined signal level; or
(c) a common signal level negotiated among the headsets based on a level of ambient noise measured by the headsets.

21. The system of claim 20, wherein each of the headsets adjusts the signal level of its user's voice by adjusting a gain applied to signals associated with the user's voice, taking into consideration a level of ambient noise.

22. The system of claim 20, wherein each headset further comprises a user control for individually adjusting the signal level of each voice signal received by the headset.

23. The system of claim 22, wherein each of the headsets is further configured to adjust a signal level of its user's voice to be transmitted to the other headsets based on individual adjustments made by the headset users.

24. The system of claim 20, wherein the headsets communicate through a private network.

25. A system of headsets, each having a first microphone for receiving a headset user's voice, a second microphone for receiving ambient noise, a receiver for receiving voice signals from the other headsets, and a speaker for delivering sound to an ear of the user, each of the headsets configured to:
identify a signal level of a first one of the voice signals;
identify a signal level of a second one of the voice signals, the signal level of the second voice signal being different than the signal level of the first voice signal;
measure a level of ambient noise;
adjust a gain applied to at least one of the first and second voice signals to normalize the signal levels of the first and second voice signals, taking into consideration the level of ambient noise; and
provide the first and second voice signals to the speaker.

26. The system of claim 25, wherein the headsets communicate through a private network.

27. The system of claim 25, wherein each headset further comprises a user control to individually adjust the signal level of each voice signal received by the headset.

28. The system of claim 27, wherein each of the headsets is further configured to adjust a signal level of each voice signal received by the headset based on individual adjustments made by the headset users.

29. The system of claim 25, wherein the signal levels of the signals provided to the speaker are substantially the same.

30. The system of claim 25, wherein the signal levels of the signals provided to the speaker are at a predetermined level above the level of ambient noise.
